(19) United States
(12) Patent Application Publication
(10) Pub. No.: US 2026/0116030 A1
(43) Pub. Date: Apr. 30, 2026

(54) METHOD FOR PRODUCING OPTICAL ELEMENT AND OPTICAL ELEMENT

(71) Applicant: Panasonic Intellectual Property Management Co., Ltd., Osaka (JP)

(72) Inventors: TAKAMASA TAMURA, Osaka (JP); TOSHIAKI TAKANO, Osaka (JP); MICHIRU KUROMIYA, Osaka (JP); TORU FURUSHIGE, Osaka (JP); YUJI YAMAMOTO, Osaka (JP)

(21) Appl. No.: 19/432,985

(22) Filed: Dec. 25, 2025

Related U.S. Application Data
(63) Continuation of application No. PCT/JP2024/020585, filed on Jun. 5, 2024.

(30) Foreign Application Priority Data
Jul. 13, 2023 (JP) 2023-115305

(51) Int. Cl. B29D 11/00

(52) U.S. Cl. CPC B29D 11/0074

(57) ABSTRACT

The method for producing an optical element includes producing a duplication mold by transfer from a master mold and producing an optical element by transfer from the duplication mold.

### TECHNICAL FIELD

The present disclosure relates to a method for producing an optical element and an optical element.

### BACKGROUND ART

As a method for producing an optical element having a fine pattern of submicron order, there is patterning by a semiconductor process. However, since this is costly, nanoimprint technology is used to duplicate a plurality of optical elements from one master mold.

In general, an inverted shape of an optical element pattern is formed as a master mold, and a desired normal rotation pattern is obtained by nanoimprinting using the inverted shape. However, it may be difficult to produce an inverted pattern depending on the pattern shape. In this case, a master mold having a normal rotation pattern is produced, a duplication mold having an inverted shape is produced by transfer of the master mold, and then transfer is performed again (by transferring twice) to produce a desired pattern.

A brittle material is often used for the master mold. In this case, a fine pattern portion of the master mold may be damaged by a plurality of times of imprinting. That is, the number of optical elements (products) that can be duplicated from one master mold (mold life) is limited. In addition, the number of times that copying can be performed (mold life) tends to decrease as the pattern becomes more complicated and finer. Therefore, in order to produce a large amount of elements, a plurality of duplication (transfer) molds may be produced from the master mold, and elements may be produced from the duplication molds.

PTL 1 discloses that the elastic modulus of resin layer 104 is made smaller than the elastic modulus of fine pattern-formed layer 102, and the elastic modulus of first pressure substrate 106 is made smaller than the elastic modulus of resin layer 104. As a result, followability of the mold is improved to take measures against transfer failure.

### CITATION LIST

### Patent Literature

PTL 1: Unexamined Japanese Patent Publication No. 2010-99848

### SUMMARY OF THE INVENTION

In imprinting to perform transfer a plurality of times, it is required to suppress damage of a master mold, a duplication mold, and an optical element which is a product. An object of the present disclosure is to realize improvement in yield by suppressing damage of a master mold and a product in a method for producing an optical element.

The method for producing an optical element of the present disclosure includes producing a duplication mold by transfer from a master mold and producing an optical element by transfer from the duplication mold. A formula (1) of M1>E>M2 is established, where an elastic modulus of a master pattern portion included in the master mold is denoted by M1, an elastic modulus of a duplication pattern portion included in the duplication mold is denoted by M2, and an elastic modulus of an element pattern portion included in the optical element is denoted by E.

An optical element of the present disclosure includes a substrate, an element pattern portion formed on the substrate and having an optical function, and a damage determination pattern portion formed outside a region where the element pattern portion is formed on the substrate. The element pattern portion includes a periodic pattern having a first period. The damage determination pattern portion includes a periodic pattern having a second period smaller than the first period.

According to the present disclosure, the life of the master mold can be extended by setting the relationship among elastic modulus M1 of the master pattern portion, elastic modulus M2 of the duplication pattern portion, and elastic modulus E of the element pattern portion.

### BRIEF DESCRIPTION OF THE DRAWINGS

FIG. 1 is a schematic cross-sectional view for explaining a method for producing an optical element of the present disclosure.

FIG. 2 is a view illustrating a state where an imprint element is released from a mold.

FIG. 3 is a view illustrating a state where an imprint element is released from a mold.

FIG. 4 is a schematic plan view for explaining production of an optical element including a damage determination pattern portion of the present disclosure.

FIG. 5 is a diagram for comparing a damage determination pattern portion and an effective pattern portion.

### DESCRIPTION OF EMBODIMENT

Hereinafter, exemplary embodiments will be described with reference to the drawings. The following description is illustrative and not restrictive. In addition, changes can be made as appropriate within a range in which the effects are exhibited.

### (Method for Producing Optical Element)

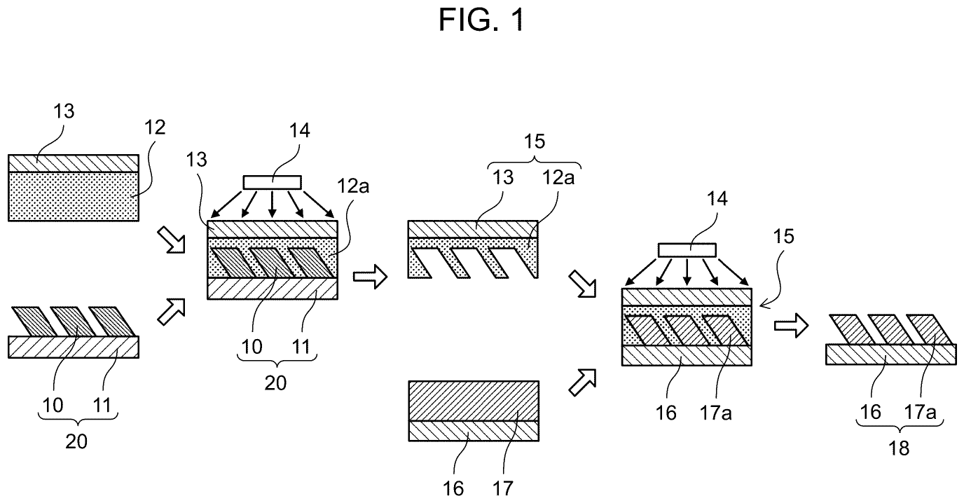

FIG. 1 is a view schematically illustrating a method for producing an optical element of the present exemplary embodiment.

First, master mold 20 illustrated in the lower left of FIG. 1 is prepared. Master mold 20 is formed of Si and includes substrate 11 and master pattern portion 10 arranged on substrate 11. Master mold 20 is produced by using a semiconductor process such as electron beam drawing or etching, and includes master pattern portion 10 which is fine and has a submicron-period line-and-space (L/S) pattern.

Duplication mold 15 (the center and the upper side in FIG. 1) is produced using such master mold 20. For this purpose, it is prepared that polymerized ultraviolet curable resin 12 (UV resin for duplication mold) using an acrylic compound is dropped onto polyethylene terephthalate (PET) resin sheet 13. At the upper left of FIG. 1, ultraviolet curable resin 12 is arranged below resin sheet 13.

Next, ultraviolet curable resin 12 on resin sheet 13 is pressed against master mold 20, and the shape of master pattern portion 10 is transferred to ultraviolet curable resin 12. Further, ultraviolet rays are irradiated from UV light source 14 to transmit resin sheet 13, and ultraviolet curable resin 12 is cured.

Thereafter, when master mold 20 is released, duplication mold 15 is obtained. Duplication mold 15 obtained by such UV imprinting has a configuration that duplication pattern portion 12a formed of cured ultraviolet curable resin 12 is formed on resin sheet 13.

Next, optical element 18 (the right end of FIG. 1) as a product is produced using duplication mold 15. This is performed using UV imprinting again.

First, optical element UV resin 17 using an acrylic compound is dropped on high-refractive index glass plate 16 which has been mirror-polished and is to be a substrate of optical element 18 (the center and the bottom of FIG. 1). The refractive index of optical element UV resin 17 used here is adjusted by mixing zinc oxide (ZnO) fine particles.

Optical element UV resin 17 on high-refractive index glass plate 16 is pressed against duplication mold 15, and the shape of duplication pattern portion 12a is transferred to optical element UV resin 17. Further, ultraviolet rays are irradiated from UV light source 14 to transmit duplication mold 15, and optical element UV resin 17 is cured.

Thereafter, when duplication mold 15 is released, optical element 18 is obtained. Optical element 18 has a configuration that element pattern portion 17a including cured optical element UV resin 17 is formed on high-refractive index glass plate 16. Element pattern portion 17a has the same pattern (normal rotation pattern) as master pattern portion 10 of master mold 20 by transferring master pattern portion 10 twice.

Here, the elastic modulus of master mold 20 (more specifically, master pattern portion 10) is M1, the elastic modulus of duplication mold 15 (more specifically, duplication pattern portion 12a) is M2, and the elastic modulus of optical element 18 (more specifically, element pattern portion 17a) is E.

For each elastic modulus, the following formula (1)

$$M 1 > E > M 2 \qquad ( 1 )$$

is established. In the present exemplary embodiment, as an example, when the elastic modulus is expressed by Young's modulus, M1 is 72 GPa, M2 is 0.4 GPa, and E is 1.7 GPa, and formula (1) is established. In the following description, examples of numerical values of the elastic modulus are all expressed by Young's modulus.

Note that M1 exceeds 10 times E, and in that sense, it can be expressed as M1>>E>M2.

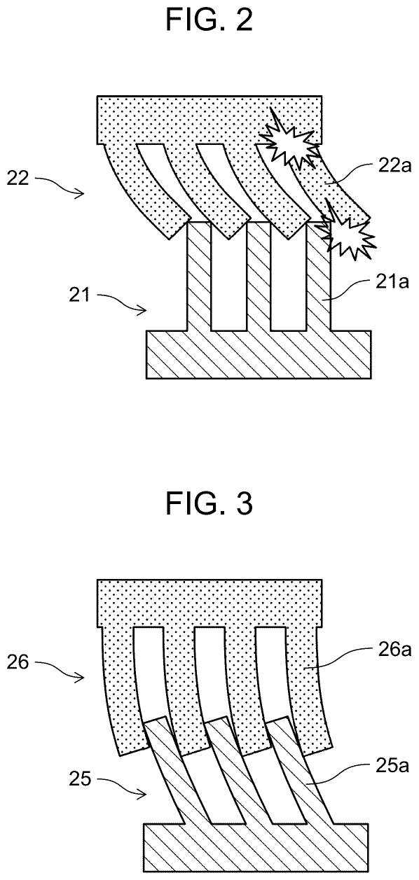

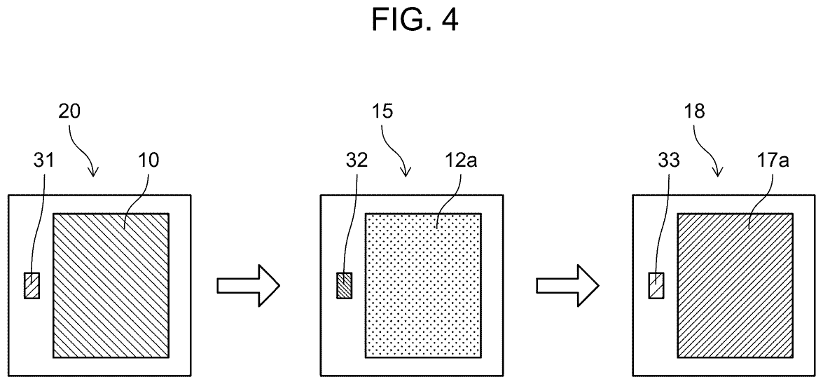

By establishing formula (1), it is possible to suppress damage of master mold 20 and optical element 18. This will be described with reference to FIG. 2 and FIG. 3.

FIG. 2 is a diagram illustrating a situation where imprint element 22 including inverted pattern portion 22a obtained by transferring the shape of fine pattern portion 21a is released from mold 21 including fine pattern portion 21a.

Here, it is assumed that the elastic modulus of fine pattern portion 21a is significantly larger than the elastic modulus of inverted pattern portion 22a. In this case, when imprint element 22 is released, fine pattern portion 21a is hardly deformed, and only inverted pattern 22a is greatly deformed. As a result, inverted pattern portion 22a is deformed more than elastically deformed, and in particular, the root, the tip portion, and the like are easily broken. That is, inverted pattern portion 22a of imprint element 22 is easily damaged.

Note that in a case where the elastic modulus of inverted pattern portion 22a is significantly larger than the elastic modulus of fine pattern portion 21a, fine pattern portion 21a of mold 21 is easily damaged at the time of mold release.

On the other hand, FIG. 3 is a diagram illustrating a situation where imprint element 26 including inverted pattern portion 26a obtained by transferring the shape of fine pattern portion 25a is released from mold 25 including fine pattern portion 25a as in FIG. 2. However, in the case of FIG. 3, the elastic modulus of fine pattern portion 25a of mold 25 is relatively small, and is a value close to the elastic modulus of inverted pattern portion 26b of imprint element 26. In this case, when imprint element 26 is released, both fine pattern portion 25a and inverted pattern portion 26a are deformed to the same extent. Therefore, the deformation amount of inverted pattern portion 26a is smaller than that in the case of FIG. 2. As a result, damage to inverted pattern portion 26a at the time of mold release is suppressed. Fine pattern portion 25a is only deformed to be relatively small, and is hardly damaged.

In the present exemplary embodiment, elastic modulus M1 of master mold 20 is significantly larger than elastic modulus M2 of duplication mold 15 (M1 is 72 GPa, M2 is 0.4 GPa). For this reason, in a case where duplication mold 15 is produced from master mold 20 by imprinting, if damage occurs, it is on duplication mold 15 side, and master mold 20 is less likely to be damaged. Therefore, even if a mold release failure occurs, the material of duplication mold 15 which has been damaged remains in master mold 20 without damage, and master mold 20 can be regenerated by cleaning or the like.

Since master mold 20 is produced by a semiconductor process, the producing cost is very high. Therefore, extending the mold life while avoiding damage of master mold 20 contributes to cost reduction of producing optical element 18. Since the production cost of duplication mold 15 is lower than the production cost of master mold 20, an increase in cost due to damage is small.

From the above, elastic modulus M1 of master mold 20 is preferably 10 times or more greater than elastic modulus M2 of duplication mold 15, and more preferably 100 times or more greater than elastic modulus M2 of duplication mold 15.

On the other hand, in the present exemplary embodiment, elastic modulus E of element pattern portion 17a in optical element 18 is slightly larger than elastic modulus M2 of duplication pattern portion 12a in duplication mold 15 (E is 1.7 GPa, M2 is 0.4 GPa). As a result, when optical element 18 is released from duplication mold 15, damage to element pattern portion 17a is suppressed, and even if damage occurs, damage is likely to occur on a side of duplication pattern portion 12a. Since high-refractive index glass plate 16 and optical element UV resin 17 forming optical element 18 are expensive, even if duplication mold 15 is damaged, suppressing the damage of optical element 18 is effective for cost reduction.

From the above, elastic modulus E of optical element 18 is preferably about 1.5 times to 10 times, and more preferably about 2 times to 5 times elastic modulus M2 of duplication mold 15.

Note that, instead of a wafer made of silicon (Si), a glass substrate such as quartz (SiO₂) or a Si wafer having an oxide film SiO₂ formed on the surface thereof may be used for master mold 20. Further, a nickel (Ni) mold duplicated from a mold such as Si or glass by electroforming may be used as master mold 20. In order to improve releasability at the time of imprinting, it is desirable to apply a fluorine-based release agent to master mold 20.

Element pattern portion 17a (and master pattern portion 10, duplication pattern portion 12a for forming element pattern portion 17a) of optical element 18 has a periodic pattern having a period of about submicron, for example, from about 90 nm to 900 nm. In particular, in a case where a periodic pattern of about 90 nm to several hundred nm is provided, the effect of suppressing mold release failure (damage) by establishing formula (1) is high.

Next, PET has been described as an example of resin sheet 13 of duplication mold 15, but a sheet of another resin such as polyethylene (PE) may be used. Resin sheet 13 desirably has flexibility from the viewpoint of releasability. Further, since resin sheet 13 uses UV imprinting, it is preferable that the resin sheet is transparent (transmitting ultraviolet rays) and thin (for example, 0.5 mm or less).

The UV resin for duplication mold 15 preferably includes a fluorine compound for improving releasability at the time of imprinting.

In order to adjust the refractive index of optical element UV resin 17 used for optical element 18, fine particles having a high refractive index other than ZnO exemplified may be used. For example, metal oxide fine particles such as Zr, Ti, Sn, Ce, Ta, and Nb can be used.

In addition, in the present exemplary embodiment, an aspect has been described that duplication mold 15 is produced from master mold 20 and optical element 18 is produced from duplication mold 15. That is, optical element 18 is produced by two times of transfer.

However, a first duplication mold may be produced from master mold 20, a second duplication mold may be produced from the first duplication mold, and optical element 18 may be further produced from the second duplication mold. In this case, optical element 18 is produced by three times of transfer. In this case, elastic modulus M2 of the first duplication mold and elastic modulus M3 of the second duplication mold are preferably substantially equal (M2≈M3). A formula indicating the relationship of the elastic modulus is as follows:

$$M 1 > E > M 2 = M 3.$$

As a result, it is possible to suppress the occurrence of a mold release failure at the time of releasing from the first duplication mold and the second duplication mold.

In addition, it is preferable that elastic modulus M1 of master mold 20 is about 20 GPa to 400 GPa, the elastic modulus of duplication mold 15 is about 0.08 GPa to 2 GPa, and elastic modulus E of optical element 18 is about 0.5 GPa to 15 GPa.

### (Damage Determination Pattern Portion)

Next, the damage determination pattern portion will be described. FIG. 4 is a diagram illustrating that duplication mold 15 is produced using master mold 20, and optical element 18 is produced using duplication mold 15, as a schematic plan view.

Optical element 18 includes an element pattern portion 17a and includes an optical effective surface having an optical function. As described with reference to FIG. 1 and the like, element pattern portion 17a is formed by transferring master pattern portion 10 of master mold 20 as duplication pattern portion 12a of duplication mold 15 and transferring this again. Hereinafter, any or all of element pattern portion 17a, master pattern portion 10, and duplication pattern portion 12a may be referred to as an effective pattern portion.

Master mold 20 includes a first damage determination pattern portion 31 outside a region where master pattern portion 10 is formed. In a case where master pattern portion 10 is transferred to duplication mold 15 as duplication pattern portion 12a, first damage determination pattern portion 31 is simultaneously transferred as second damage determination pattern portion 32. Further, in a case where duplication pattern portion 12a is transferred to optical element 18 as element pattern portion 17a, second damage determination pattern portion 32 is simultaneously transferred as third damage determination pattern portion 33.

Element pattern portion 17a is a periodic pattern having a first period (pitch). Naturally, master pattern portion 10 and duplication pattern portion 12a also have the same first period. On the other hand, first to third damage determination pattern portions 31, 32, and 33 are periodic patterns having a second period smaller than the first period.

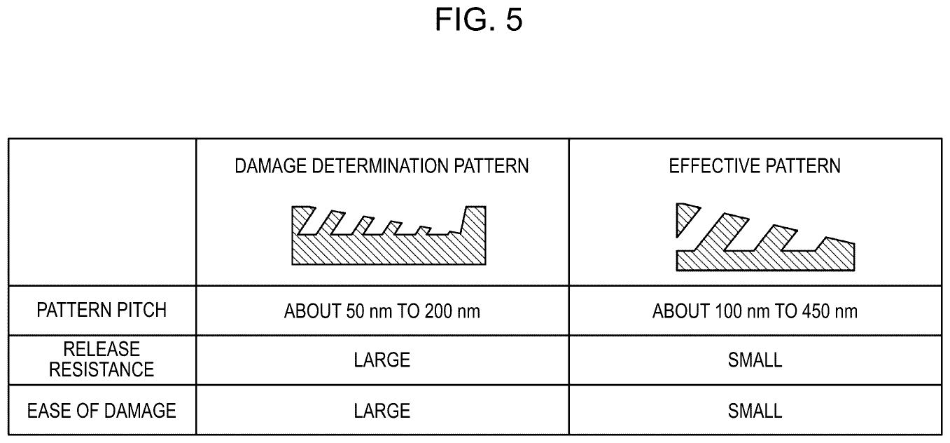

FIG. 5 schematically illustrates cross sections of the damage determination pattern portion and the effective pattern portion. Note that the period (second period) of the damage determination pattern portion is preferably about half or less of the period (first period) of the effective pattern portion. For example, when the first period is about 100 nm to 450 nm, the second period is preferably about 50 nm to 200 nm.

The damage determination pattern portion has a period smaller than the period of the effective pattern portion, and thus is fragile. In addition, since the period is small, the surface area increases, and the mold release resistance increases. Therefore, the damage determination pattern portion is more likely to be damaged at the time of mold release than the effective pattern portion, and there is a high possibility that the damage determination pattern portion is damaged earlier than the effective pattern portion. That is, by observing the damage of the damage determination pattern portion, it is possible to know a sign of damage of the effective pattern portion.

Optical element 18 of the present exemplary embodiment is formed using high-refractive index glass plate 16 and optical element UV resin 17 which are expensive materials. Therefore, when the yield of the product decreases, the influence on the product cost is large. Therefore, by checking a sign of damage of the effective pattern portion using the damage determination pattern portion, it is possible to suppress damage of the effective pattern portion (element pattern portion 17a) in optical element 18 which is a product and to improve a yield.

For example, in a case where duplication pattern portion 12a of duplication mold 15 is already damaged, it is a matter of course that element pattern portion 17a of optical element 18 is not correctly formed when transfer is performed using the duplication mold.

In addition, in a case where damage occurs in duplication pattern portion 12a when optical element 18 is released from duplication mold 15, the occurrence of a defect in optical element 18 is suppressed by the above-described relationship of elastic modulus (E>M2). In addition, if a countermeasure is taken at the time of observing a sign of damage in duplication mold 15, the occurrence of defective products can be more reliably prevented.

In addition, in a case where duplication mold 15 is formed from master mold 20, second damage determination pattern portion 32 on a side of duplication mold 15 is damaged when damage occurs due to the relationship of the elastic modulus (M1>M2) described above. When this occurs, at that time, master mold 20 is cleaned and re-released, and master mold 20 is regenerated.

In a case where second damage determination pattern portion 32 is damaged when duplication mold 15 is released, there is usually no problem in duplication pattern portion 12a at that time. However, considering that damage determination pattern portion 32 is also used in a case where optical element 18 is produced using duplication mold 15, it is desirable not to use duplication mold 15 with the damage determination pattern portion 32 which is damaged.

As long as element pattern portion 17a is correctly formed, optical element 18 can be used without any problem even if third damage determination pattern portion 33 is damaged.

As described above, by providing the damage determination pattern portion, the yield of producing optical element 18 can be improved, and the product cost can be reduced.

The exemplary embodiments described above can be modified in form and details without departing from the spirit of the claims. In addition, the contents of each exemplary embodiment can be appropriately combined and replaced as long as the functions of the object of the present disclosure are not impaired.

### INDUSTRIAL APPLICABILITY

According to the present disclosure, since the life of the master mold can be extended, it is useful in producing an optical element using imprinting.

### REFERENCE MARKS IN THE DRAWINGS

10: master pattern portion
11: substrate
12: ultraviolet curable resin
12a: duplication pattern portion
13: resin sheet
14: UV light source
15: duplication mold
16: high-refractive index glass plate
17: optical element UV resin
17a: element pattern portion
18: optical element
20: master mold
21: mold
21a: fine pattern portion
22: imprint element
22a: inverted pattern portion
25: mold
25a: fine pattern portion
26: imprint element
26a: inverted pattern portion
26b: inverted pattern portion
31, 32, 33: damage determination pattern portion

1. A method for producing an optical element including producing a duplication mold by transfer from a master mold and producing an optical element by transfer from the duplication mold, wherein
where an elastic modulus of a master pattern portion included in the master mold is denoted by M1, an elastic modulus of a duplication pattern portion included in the duplication mold is denoted by M2, and an elastic modulus of an element pattern portion included in the optical element is denoted by E, a formula (1)
$$M 1 > E > M 2 \qquad ( 1 )$$
is established.

2. The method according to claim 1, wherein
M1 is 10 times or more greater than E.

3. The method according to claim 1, wherein
the optical element includes a substrate and the element pattern portion formed on the substrate, and
the element pattern portion includes a pattern extending in an inclined manner with respect to a direction perpendicular to a surface of the substrate.

4. The method according to claim 1, wherein
the duplication mold and the element pattern portion are formed of a resin material which is an ultraviolet curable resin.

5. The method according to claim 1, wherein
the element pattern portion includes a periodic pattern having a period of 90 nm to 900 nm.

6. The method according to claim 1, wherein
the master mold and the duplication mold include a first periodic pattern for forming the element pattern portion of the optical element and a second periodic pattern having a period smaller than a period of the first periodic pattern.

7. An optical element comprising:
a substrate;
an element pattern portion formed on the substrate and having an optical function; and
a damage determination pattern portion formed outside a region where the element pattern portion is formed on the substrate, wherein
the element pattern portion includes a periodic pattern having a first period, and
the damage determination pattern portion includes a periodic pattern having a second period smaller than the first period.
